(19) United States
(12) Patent Application Publication
(10) Pub. No.: US 2022/0045362 A1
(43) Pub. Date: Feb. 10, 2022

(54) ELECTROLYTE, LITHIUM-ION BATTERY, AND APPARATUS CONTAINING SUCH LITHIUM-ION BATTERY

(71) Applicant: CONTEMPORARY AMPEREX TECHNOLOGY CO., LIMITED, Ningde City (CN)

(72) Inventors: Peipei CHEN, Ningde City (CN); Chenghua Fu, Ningde City (CN); Bin Jiang, Ningde City (DE); Chengdu Liang, Ningde City (CN)

(21) Appl. No.: 17/511,379

(22) Filed: Oct. 26, 2021

Related U.S. Application Data
(63) Continuation of application No. PCT/CN2020/083610, filed on Apr. 8, 2020.

(30) Foreign Application Priority Data
Apr. 26, 2019 (CN) 201910344676.5

(51) Int. Cl. H01M 10/0567; H01M 10/0525

(52) U.S. Cl. CPC H01M 10/0567; H01M 2300/0025; H01M 10/0525

(57) ABSTRACT

This application provides an electrolyte, a lithium-ion battery, and an apparatus including such lithium-ion battery. The electrolyte includes a lithium salt, an organic solvent, and an additive. The additive includes a sulfur-containing compound and a silane compound, where the sulfur-containing compound is selected from one or more of sulfur hexafluoride, sulfuryl fluoride, sulfur dioxide, sulfur trioxide, carbon disulfide, dimethyl sulfide, and methyl ethyl sulfide. When a specific sulfur-containing compound is used together with a silane compound as an additive to the electrolyte, the sulfur-containing compound can not only participate in forming a SEI film on a surface of a negative electrode of the lithium-ion battery to effectively prevent direct contact between the electrolyte and a negative electrode active material, but also optimize a passivation film formed by the silane compound on a surface of the positive electrode to reduce film-forming impedance on the surface of the positive electrode.

### CROSS-REFERENCE TO RELATED APPLICATIONS

This application is a continuation application of PCT Patent Application No. PCT/CN2020/083610, entitled “ELECTROLYTE, LITHIUM-ION BATTERY, AND APPARATUS CONTAINING SUCH LITHIUM-ION BATTERY” filed on Apr. 8, 2020, which claims priority to Chinese Patent Application No. 201910344676.5, filed with the China National Intellectual Property Administration on Apr. 26, 2019 and entitled “ELECTROLYTE AND LITHIUM-ION BATTERY”, all of which are incorporated herein by reference in their entirety.

### TECHNICAL FIELD

This application relates to the field of battery technologies, and in particular, to an electrolyte, a lithium-ion battery, and an apparatus containing such lithium-ion battery.

### BACKGROUND

Lithium-ion batteries are widely applied to electric vehicles and consumer electronic products due to their advantages such as high energy density, high output power, long cycle life, and low environmental pollution. For applications in electric vehicles, a lithium-ion battery as a power source is required to have characteristics such as low impedance, long cycle life, long storage life, and excellent safety performance. Lower impedance helps ensure good acceleration performance and kinetic performance. When being applied to hybrid electric vehicles, lithium-ion batteries can reclaim energy and improve fuel efficiency to a greater extent, and increase the charging rates of the hybrid electric vehicles. Long storage life and long cycle life allow the lithium-ion batteries to have long-term reliability and maintain good performance in the normal life cycles of the hybrid electric vehicles.

Interaction between an electrolyte and positive and negative electrodes has a great impact on the performance of a lithium-ion battery. Therefore, to meet the requirements of hybrid electric vehicles for power, it is necessary to provide an electrolyte and a lithium-ion battery with good comprehensive performance.

### SUMMARY

In view of the problems in the Background, this application is intended to provide an electrolyte, a lithium-ion battery, and an apparatus containing such lithium-ion battery, where the lithium-ion battery can have both good high-temperature cycling performance and good low-temperature discharge performance.

In order to achieve the foregoing objective, a first aspect of this application provides an electrolyte, including a lithium salt, an organic solvent, and an additive. The additive includes a sulfur-containing compound and a silane compound, where the sulfur-containing compound is selected from one or more of sulfur hexafluoride, sulfuryl fluoride, sulfur dioxide, sulfur trioxide, carbon disulfide, dimethyl sulfide, and methyl ethyl sulfide.

A second aspect of this application provides a lithium-ion battery, including a positive electrode plate, a negative electrode plate, a separator, and an electrolyte. The positive electrode plate includes a positive electrode current collector and a positive electrode membrane that is disposed on at least one surface of the positive electrode current collector and that includes a positive electrode active material; the negative electrode plate includes a negative electrode current collector and a negative electrode membrane that is disposed on at least one surface of the negative electrode current collector and that includes a negative electrode active material; and the electrolyte is the electrolyte according to the first aspect of this application.

A third aspect of this application provides an apparatus, including the lithium-ion battery according to the second aspect of this application.

This application includes at least the following beneficial effects:

In this application, a specific sulfur-containing compound is used together with a silane compound as an additive to the electrolyte. The sulfur-containing compound can not only form a SEI film on a surface of a negative electrode of the lithium-ion battery to effectively prevent direct contact between the electrolyte and the negative electrode active material, but also optimize a passivation film formed by the silane compound on a surface of a positive electrode to reduce film-forming impedance on the surface of the positive electrode. With the synergy of the sulfur-containing compound and the silane compound, the lithium-ion battery has both good high-temperature cycling performance and good low-temperature discharge performance. The apparatus of this application includes the lithium-ion battery provided by this application, and therefore has at least the same advantages as the lithium-ion battery.

### BRIEF DESCRIPTION OF DRAWINGS

To describe the technical solutions in the embodiments of this application more clearly, the following briefly describes the accompanying drawings required for describing the embodiments of this application. Apparently, the accompanying drawings in the following description show merely some embodiments of this application, and a person of ordinary skill in the art may still derive other drawings from these accompanying drawings without creative efforts.

FIG. 1 is a schematic diagram of an embodiment of a lithium-ion battery.

FIG. 2 is an exploded view of FIG. 1.

FIG. 3 is a schematic diagram of an embodiment of a battery module.

FIG. 4 is a schematic diagram of an embodiment of a battery pack.

FIG. 5 is an exploded view of FIG. 4.

FIG. 6 is a schematic diagram of an embodiment of an apparatus using a lithium-ion battery as a power source.

### DESCRIPTION OF EMBODIMENTS

To make the objectives, technical solutions, and advantages of the embodiments of this application clearer, the following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The electrolyte and lithium-ion battery of this application are described in detail below.

An electrolyte according to a first aspect of this application is described first.

The electrolyte according to the first aspect of this application includes a lithium salt, an organic solvent, and an additive. The additive includes a sulfur-containing compound and a silane compound, where the sulfur-containing compound is selected from one or more of sulfur hexafluoride (SF₆), sulfuryl fluoride (SO₂F₂), sulfur dioxide (SO₂), sulfur trioxide (SO₃), carbon disulfide (CS₂), dimethyl sulfide (CH₂SCH₃), and methyl ethyl sulfide.

For a negative electrode of a lithium-ion battery, in the first charge and discharge cycle, the lithium salt and organic solvent in the electrolyte may undergo a reduction reaction on a surface of a negative electrode active material, and the reaction product is deposited on a surface of a negative electrode to form a dense solid electrolyte interphase (SEI) film. The SEI film is insoluble in organic solvents, and therefore can exist stably in the electrolyte. Also, the SEI film does not allow molecules of the organic solvent to pass through, thereby effectively preventing co-intercalation of solvent molecules and avoiding damage to the negative electrode active material caused by the co-intercalation of solvent molecules. Therefore, the SEI film greatly improves the cycling performance and service life of the lithium-ion battery.

For a positive electrode of the lithium-ion battery, under the action of CO₂ in the air, a surface of a lithium-containing positive electrode active material is generally covered by a Li₂CO₃ film. Therefore, when the Li₂CO₃ film comes into contact with the electrolyte, the electrolyte can be oxidized on the surface of the positive electrode whether in storage or in charge-discharge cycling, and the product of oxidative decomposition will be deposited on the surface of the positive electrode to replace the original Li₂CO₃ film and form a new passivation film. The formation of the new passivation film will not only increase irreversible capacity of the positive electrode active material and reduce the charge and discharge efficiency of the lithium-ion battery, but also hinder deintercalation and intercalation of lithium ions in the positive electrode active material to some extent, thereby deteriorating cycling performance and charge-discharge performance of the lithium-ion battery.

During charge/discharge of the lithium-ion battery, the silane compound can form a film on a surface of a positive electrode membrane of the lithium-ion battery to improve high-temperature cycling performance of the lithium-ion battery. However, the silane compound has relatively high film-forming impedance, which is not conducive to improving low-temperature performance of the lithium-ion battery. The sulfur-containing compound can form a passivation film on surfaces of both the positive and negative electrodes of the lithium-ion battery. The passivation film (also called solid electrolyte interphase film, SEI film) formed on the surface of the negative electrode can prevent direct contact between the electrolyte and the negative electrode active material, thereby inhibiting the reduction reaction of the electrolyte. When both the silane compound and the sulfur-containing compound are used, on the one hand, the sulfur-containing compound can form a SEI film on the surface of the negative electrode, thereby effectively preventing direct contact between the electrolyte and the negative electrode active material, and on the other hand, the sulfur-containing compound can optimize the passivation film formed by the silane compound on the surface of the positive electrode. The synergy of the two compounds allows the passivation film formed on the surface of the positive electrode to contain a Si—O—SO₂— component, thereby effectively reducing the film-forming impedance on the surface of the positive electrode and further improving low-temperature discharge performance of the lithium-ion battery. In addition, the particular sulfur-containing compound exhibits weak interaction between molecules, and after being dissolved in the electrolyte, can effectively reduce viscosity of the electrolyte, thereby effectively preventing solidification of the electrolyte at low temperatures and further improving the low-temperature discharge performance of the battery.

The electrolyte of this application includes both particular sulfur-containing and silane compounds, and the lithium ion battery can have both good high-temperature cycling performance and good low-temperature discharge performance.

Preferably, the sulfur-containing compound may be selected from one or more of sulfur hexafluoride (SF₆), sulfuryl fluoride (SO₂F₂), sulfur dioxide (SO₂), and sulfur trioxide (SO₃).

In the electrolyte according to the first aspect of this application, the silane compound is selected from one or more of compounds represented by formula 1, formula 2, and formula 3, where R₁₁, R₁₂, R₁₃, R₁₄, R₁₅, R₁₆, R₁₇, R₁₈, R₁₉, R₂₁, R₂₂, R₂₃, R₂₄, R₂₅, R₂₆, R₂₇, R₂₈, R₂₉, R₃₁, R₃₂, R₃₃, R₃₄, R₃₅, R₃₆, R₃₇, R₃₈, and R₃₉ are each independently selected from one or more of C1 to C6 alkyl groups or C1 to C6 haloalkyl groups:

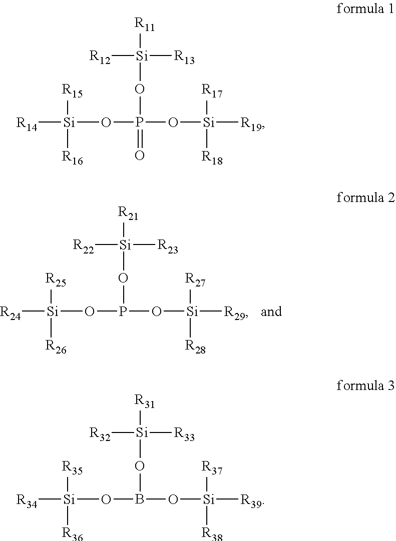

In the electrolyte according to the first aspect of this application, specifically, the silane compound can be selected from one or more of tris(trimethyl)silane phosphate, tris(trimethyl)silane phosphite, tris(trimethyl) silane borate, tris(triethyl)silane phosphate, tris(triethyl)silane phosphite, tris(triethyl)silane borate, tris(trifluoromethyl)silane phosphate, tris(trifluoromethyl)silane phosphite, tris(trifluoromethyl)silane borate, tris(2,2,2-trifluoroethyl)silane phosphate, tris(2,2,2-trisfluoroethyl)silane phosphite, tris(2,2,2-trifluoroethyl)silane borate, tris(hexafluoroisopropyl)silane phosphate, tris(hexafluoroisopropyl)silane phosphite, and tris(hexafluoroisopropyl) silane borate.

In the electrolyte according to the first aspect of this application, the sulfur-containing compound can not only participate in forming a passivation film on the surface of the positive electrode of the lithium-ion battery but also participate in forming a SEI film on the surface of the negative electrode of the lithium-ion battery. Therefore, if the proportion of the sulfur-containing compound is excessively low, it is difficult for the sulfur-containing compound to cooperate with the silane compound to form a complete passivation film on the surface of the positive electrode and also difficult for it to form a complete SEI film on the surface of the negative electrode. Therefore, the direct contact between the electrolyte and the positive and negative electrode active materials cannot be effectively prevented. If the proportion of the sulfur-containing compound is excessively high, reaction products produced by oxidative decomposition of excessive sulfur-containing compound will accumulate on the surface of the positive electrode, increasing impedance of the passivation film formed on the surface of the positive electrode, thereby deteriorating high-temperature cycling performance of the lithium-ion battery.

In some embodiments, mass of the sulfur-containing compound is 0.1% to 8% of total mass of the electrolyte.

Further in some embodiments, the mass of the sulfur-containing compound is 0.5% to 5% of the total mass of the electrolyte.

In the electrolyte according to the first aspect of this application, if the proportion of the silane compound is excessively low, the passivation film formed by the silane compound on the surface of the positive electrode can hardly effectively prevent the direct contact between the electrolyte and the positive electrode active materials, which is not conducive to improving high-temperature cycling performance of the lithium-ion battery; and if the proportion of the silane compound is excessively high, excessive silane compound will accumulate on the surface of the positive and negative electrodes, increasing film-forming impedance on the surfaces of the positive and negative electrodes, thereby deteriorating performance of the lithium-ion battery.

In some embodiments, mass of the silane compound is 0.1% to 5% of total mass of the electrolyte.

Further in some embodiments, the mass of the silane compound is 0.1% to 3% of the total mass of the electrolyte.

In the electrolyte according to the first aspect of this application, the sulfur-containing compound is used together with the silane compound as an additive to the electrolyte. Therefore, setting a reasonable mass ratio for the two compounds in the electrolyte can give full play to their respective functions while ensuring their synergy, which can not only further improve low-temperature discharge performance and high-temperature cycling performance of the lithium-ion battery, but also reduce costs.

Preferably, in the electrolyte, a mass percentage of the sulfur-containing compound is greater than a mass percentage of the silane compound.

In the electrolyte according to the first aspect of this application, the lithium salt is not limited to any particular type but can be selected according to actual needs. Specifically, the lithium salt can be selected from one or more of LiN(CₓF₂ₓ₊₁SO₂)(C_{y}F_{2y+1}SO₂), LiPF₆, LiBF₄, LiBOB, LiAsF₆, Li(CF₃SO₂)₂N, LiCF₃SO₃, and LiClO₄, where x and y are natural numbers.

In the electrolyte according to the first aspect of this application, the organic solvent is not limited to any particular type but can be selected according to actual needs. Specifically, the organic solvent may be selected from one or more of propylene carbonate, ethylene carbonate, dimethyl carbonate, diethyl carbonate, dipropyl carbonate, ethyl methyl carbonate, methyl propyl carbonate, vinylene carbonate, fluoroethylene carbonate, methyl formate, ethyl acetate, ethyl propionate, propyl propionate, methyl butyrate, methyl acrylate, vinyl sulfite, propylene sulfite, dimethyl sulfite, diethyl sulfite, 1,3-propane sultone, vinyl sulfate, acid anhydride, N-methylpyrrolidone, N-methylformamide, N-methylacetamide, acetonitrile, N,N-dimethylformamide, sulfolane, dimethyl sulfoxide, dimethyl sulfide, γ-butyrolactone, and tetrahydrofuran.

Next, a lithium-ion battery according to a second aspect of this application is described.

The lithium-ion battery according to the second aspect of this application includes a positive electrode plate, a negative electrode plate, a separator, and an electrolyte. The positive electrode plate includes a positive electrode current collector and a positive electrode membrane that is disposed on at least one surface of the positive electrode current collector and that includes a positive electrode active material, and the negative electrode plate includes a negative electrode current collector and a negative electrode membrane that is disposed on at least one surface of the negative electrode current collector and that includes a negative electrode active material. The electrolyte is the electrolyte according to the first aspect of this application. In the lithium-ion battery according to the second aspect of this application, the positive electrode active material is selected from materials capable of deintercalating and intercalating lithium ions. Specifically, the positive electrode active material may be selected from one or more of lithium cobalt oxides, lithium nickel oxides, lithium manganese oxides, lithium nickel manganese oxides, lithium nickel cobalt manganese oxides, lithium nickel cobalt aluminum oxides, and compounds obtained by adding other transition metals or non-transition metals to such compounds. However, this application is not limited to these materials.

In the lithium-ion battery according to the second aspect of this application, the negative electrode active material is selected from materials capable of intercalating and deintercalating lithium ions. Specifically, the negative electrode active material may be selected from one or more of carbon materials, silicon-based materials, tin-based materials, and lithium titanate, but this application is not limited to these materials. The carbon material can be selected from one or more of graphite, soft carbon, hard carbon, carbon fiber, and carbonaceous mesophase spherule; the graphite can be selected from one or more of artificial graphite and natural graphite; the silicon-based material may be selected from one or more of elemental silicon, silicon-oxygen compounds, silicon-carbon composites, and silicon alloys; and the tin-based material may be selected from one or more of elemental tin, tin oxide compounds, and tin alloys.

In the lithium-ion battery according to the second aspect of this application, the separator is not limited to any particular type but can be selected according to actual needs. For example, the separator may be, but is not limited to, polyethylene, polypropylene, polyvinylidene fluoride, or multilayer composite films thereof.

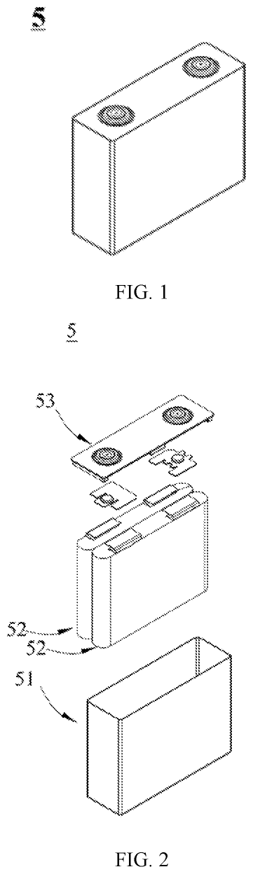

This application does not impose special limitations on a shape of the lithium-ion battery, and the lithium-ion battery may be of a cylindrical shape, a square shape, or any other shapes. FIG. 1 shows a lithium-ion battery 5 of a square structure as an example.

In some embodiments, the lithium-ion battery may include an outer package for encapsulating the positive electrode plate, the negative electrode plate, the separator, and the electrolyte.

In some embodiments, the outer package of the lithium-ion battery may be a soft package, for example, a soft bag. A material of the soft package may be plastic, for example, may include one or more of polypropylene PP, polybutylene terephthalate PBT, polybutylene succinate PBS, and the like. Alternatively, the outer package of the lithium-ion battery may be a hard shell, for example, a hard plastic shell, an aluminum shell, a steel shell, and the like.

In some embodiments, referring to FIG. 2, the outer package may include a housing 51 and a cover plate 53. The housing 51 may include a base plate and a side plate that is joined to the base plate, and the base plate and the side plate enclose an accommodating cavity. The housing 51 has an opening communicating with the accommodating cavity, and the cover plate 53 can cover the opening to close the accommodating cavity.

The positive electrode plate, the negative electrode plate, and the separator may be laminated or wound to form an electrode assembly 52 of a laminated or wound structure. The electrode assembly 52 is encapsulated in the accommodating cavity. The electrolyte infiltrates into the electrode assembly 52.

There may be one or more electrode assemblies 52 in the lithium-ion battery 5, and their quantity may be adjusted as required.

In some embodiments, such lithium-ion batteries may be combined to assemble a battery module. The battery module may include a plurality of lithium-ion batteries whose quantity may be adjusted according to the use case and capacity of the battery module.

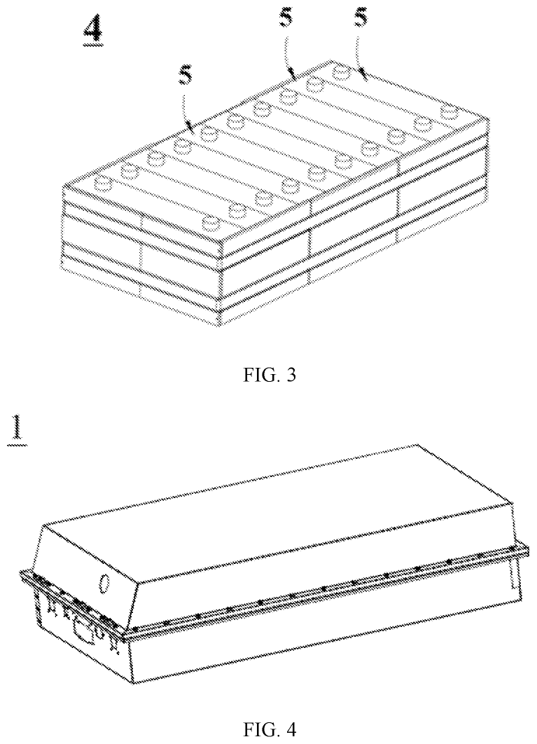

FIG. 3 shows a battery module 4 as an example. Referring to FIG. 3, in the battery module 4, a plurality of lithium-ion batteries 5 may be sequentially arranged along a length direction of the battery module 4. Certainly, the plurality of lithium metal batteries 5 may be arranged in any other manners. Further, the plurality of lithium-ion batteries 5 may be fixed by using fasteners.

Optionally, the battery module 4 may further include a housing with an accommodating space, and the plurality of lithium-ion batteries 5 are accommodated in the accommodating space.

In some embodiments, such battery modules may be further combined to assemble a battery pack, and a quantity of battery modules included in the battery pack may be adjusted based on the use case and capacity of the battery pack.

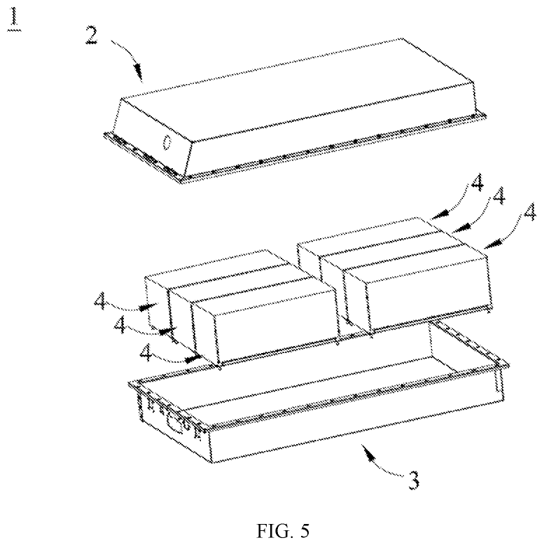

FIG. 4 and FIG. 5 show a battery pack 1 as an example. Referring to FIG. 4 and FIG. 5, the battery pack 1 may include a battery box and a plurality of battery modules 4 disposed in the battery box. The battery box includes an upper box body 2 and a lower box body 3, where the upper box body 2 can cover the lower box body 3 to form an enclosed space for accommodating the battery modules 4. The plurality of battery modules 4 may be arranged in the battery box in any manner.

A third aspect of this application provides an apparatus, where the apparatus includes the lithium-ion battery according to the second aspect of this application. The lithium-ion battery may be used as a power source for the apparatus, or an energy storage unit of the apparatus. The apparatus may be, but is not limited to, a mobile device (for example, a mobile phone or a notebook computer), an electric vehicle (for example, a battery electric vehicle, a hybrid electric vehicle, a plug-in hybrid electric vehicle, an electric bicycle, an electric scooter, an electric golf vehicle, or an electric truck), an electric train, a ship, a satellite, an energy storage system, and the like.

A lithium-ion battery, a battery module, or a battery pack may be selected for the apparatus according to requirements for using the apparatus.

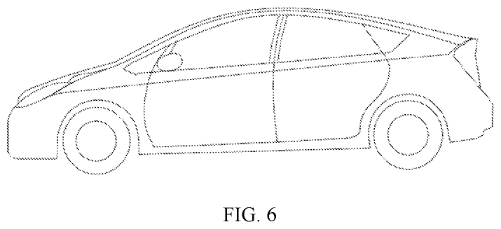

FIG. 6 shows an apparatus as an example. The apparatus is a battery electric vehicle, a hybrid electric vehicle, a plug-in hybrid electric vehicle, or the like. To meet requirements of the apparatus for high power and high energy density of a battery, a battery pack or a battery module may be used.

In another example, the apparatus may be a mobile phone, a tablet computer, a notebook computer, or the like. The apparatus is generally required to be light and thin, and may use a sodium-ion battery as its power source.

This application is further described with reference to examples. It should be understood that these examples are merely used to describe this application but not to limit the scope of this application. Various modifications and changes made without departing from the scope of the content disclosed in this application are apparent to those skilled in the art. All reagents used in the embodiments are commercially available or synthesized in a conventional manner, and can be used directly without further treatment, and all instruments used in the embodiments are commercially available.

Lithium-ion batteries in Examples 1 to 20 and Comparative Examples 1 to 3 are prepared according to the following method.

(1) Preparation of a Positive Electrode Plate

A positive electrode active material LiNi_{0.5}Mn_{0.3}Co_{0.2}O₂, a conductive agent acetylene black, and a binder polyvinylidene fluoride (PVDF) were dissolved in a solvent N-methylpyrrolidone (NMP) at a weight ratio of 94:3:3. The resulting mixture was thoroughly stirred to obtain a uniform positive electrode slurry. Then the positive electrode slurry was uniformly applied onto an aluminum (Al) foil positive electrode current collector, followed by drying, cold pressing, and cutting to obtain a positive electrode plate.

(2) Preparation of a Negative Electrode Plate

A negative electrode active material artificial graphite, a conductive agent acetylene black, a binder styrene-butadiene rubber (SBR), a thickener sodium carboxymethyl cellulose (CMC) were dissolved in deionized water at a weight ratio of 95:2:2:1. The resulting mixture was thoroughly stirred to obtain a uniform negative electrode slurry. Then the negative electrode slurry was applied onto a negative electrode current collector copper (Cu) foil, followed by drying, cold pressing, and cutting to obtain a negative electrode plate.

(3) Preparation of an Electrolyte

Ethylene carbonate (EC) and ethyl methyl carbonate (EMC) were mixed at a mass ratio of 30:70, then a lithium salt LiPF₆ with a concentration of 1 mol/L was added into the resulting mixture, followed by adding a sulfur-containing compound and a silane compound. The mixture was stirred thoroughly to obtain a uniform electrolyte. Types and proportions of the sulfur-containing compound and the silane compound are shown in Table 1.

(4) Preparation of a Separator

A polyethylene (PE) porous polymer film was used as a separator.

(5) Preparation of a Lithium-Ion Battery

The positive electrode plate, separator, and negative electrode plate were stacked in order, so that the separator was sandwiched between the positive electrode plate and the negative electrode plate for isolation, and the resulting stack was wound to obtain an electrode assembly. The electrode assembly was placed in an outer package, the prepared electrolyte was injected, and then the outer package was sealed.

Next, a test procedure for the lithium-ion battery is described as follows.

(1) Low-Temperature Discharge Performance Test for the Lithium-Ion Battery

At room temperature, the lithium-ion battery was charged at a constant current of 0.5 C to a voltage over 4.3V, then further charged at a constant voltage of 4.3V to a current below 0.05 C, and then discharged at 0.5 C to 3.0V, and a discharge capacity of the lithium-ion battery at that point was obtained and recorded as D0. Then, the lithium-ion battery was charged at a constant current of 0.5 C to a voltage over 4.3V, and then further charged at a constant voltage of 4.3V to a current below 0.05 C. The lithium-ion battery was left for 2 hours in a −10° C. environment, and then discharged to 3.0V at 0.5 C, and the discharge capacity of the lithium ion battery at that point was obtained and recorded as D1. Five lithium-ion batteries were tested per group, and average values were taken.

The discharge efficiency of the lithium-ion battery under 0.5 C at −10° C. was ε(%)=D1/D0×100%.

(2) High-Temperature Cycling Performance Test for the Lithium-Ion Battery

At 45° C., the lithium-ion battery was charged with constant current and constant voltage at 0.7 C (that is, current at which the theoretical capacity was completely discharged in 2 h) to an upper limit voltage of 4.3V, and then discharged at a constant current of 0.5 C to a voltage of 3V, which was one charge and discharge cycle. At that point, the discharge capacity was the discharge capacity of the lithium-ion battery in the first cycle. The lithium-ion battery was tested according to the above method for 500 charge and discharge cycles, and the discharge capacity of the 500th cycle was measured.

Capacity retention rate (%) of the lithium-ion battery after 500 cycles at 45° C.=(discharge capacity of the 500th cycle/discharge capacity of the first cycle)×100%

TABLE 1
Parameters and performance test results of Examples 1 to 20 and Comparative Examples 1 to 3

| | | | | | Discharge | Capacity |
|---|---|---|---|---|---|---|
| | | | | | efficiency | retention |
| | Sulfur-containing | | | | under | rate after |
| | compound | | Silane compound | | 0.5 C. | 500 cycles |
| | Type | Content | Type | Content | at-10° C. | at 45° C. |
| Example 1 | Sulfur | 0.05% | Tris(trimethyl)silane | 1.0% | 75% | 66% |
| | dioxide | | phosphate | | | |
| Example 2 | Sulfur | 0.1% | Tris(trimethyl)silane | 1.0% | 79% | 75% |
| | dioxide | | phosphate | | | |
| Example 3 | Sulfur | 0.5% | Tris(trimethyl)silane | 1.0% | 82% | 80% |
| | dioxide | | phosphate | | | |
| Example 4 | Sulfur | 1.0% | Tris(trimethyl)silane | 1.0% | 84% | 89% |
| | dioxide | | phosphate | | | |
| Example 5 | Sulfur | 2.0% | Tris(trimethyl)silane | 1.0% | 88% | 90% |
| | dioxide | | phosphate | | | |
| Example 6 | Sulfur | 3.0% | Tris(trimethyl)silane | 1.0% | 87% | 92% |
| | dioxide | | phosphate | | | |
| Example 7 | Sulfur | 5.0% | Tris(trimethyl)silane | 1.0% | 86% | 89% |
| | dioxide | | phosphate | | | |
| Example 8 | Sulfur | 8.0% | Tris(trimethyl)silane | 1.0% | 83% | 83% |
| | dioxide | | phosphate | | | |
| Example 9 | Sulfur | 10.0% | Tris(trimethyl)silane | 1.0% | 75% | 72% |
| | dioxide | | phosphate | | | |
| Example 10 | Sulfur | 3.0% | Tris(trimethyl)silane | 0.05% | 76% | 65% |
| | dioxide | | phosphate | | | |
| Example 11 | Sulfur | 3.0% | Tris(trimethyl)silane | 0.1% | 80% | 74% |
| | dioxide | | phosphate | | | |
| Example 12 | Sulfur | 3.0% | Tris(trimethyl)silane | 0.5% | 83% | 79% |
| | dioxide | | phosphate | | | |
| Example 13 | Sulfur | 3.0% | Tris(trimethyl)silane | 2.0% | 89% | 88% |
| | dioxide | | phosphate | | | |
| Example 14 | Sulfur | 3.0% | Tris(trimethyl)silane | 3.0% | 83% | 87% |
| | dioxide | | phosphate | | | |
| Example 15 | Sulfur | 3.0% | Tris(trimethyl)silane | 5.0% | 79% | 84% |
| | dioxide | | phosphate | | | |
| Example 16 | Sulfur | 3.0% | Tris(trimethyl)silane | 6.0% | 75% | 70% |
| | dioxide | | phosphate | | | |
| Example 17 | Sulfuryl | 3.0% | Tris(trimethyl)silane | 1.0% | 85% | 90% |
| | fluoride | | phosphite | | | |
| Example 18 | Sulfur | 3.0% | Tris(trimethyl) | 1.0% | 83% | 89% |
| | hexafluoride | | silane borate | | | |
| Example 18 | Carbon | 3.0% | Tris(2,2,2-fluoroethyl) | 1.0% | 82% | 88% |
| | disulfide | | phosphate | | | |
| Example 20 | Sulfur | 3.0% | Tris | 1.0% | 84% | 89% |
| | trioxide: Sulfur | | (hexafluoroisopropyl) | | | |
| | dioxide = 1:1 | | phosphate | | | |
| Comparative | / | / | / | / | 70% | 53% |
| Example 1 | | | | | | |
| Comparative | Sulfur | 3.0% | / | / | 75% | 63% |
| Example 2 | dioxide | | | | | |
| Comparative | / | / | Tris(trimethyl)silane | 1.0% | 73% | 60% |
| Example 3 | | | phosphate | | | |

It can be seen from the test results in Table 1 that compared with Comparative Examples 1 to 3, by adding particular types of sulfur-containing compounds and silane compounds to the electrolyte, Examples 1 to 20 of this application allowed the lithium-ion battery to have both good high-temperature cycling performance and good low-temperature discharge performance. In Comparative Example 1, neither a sulfur compound nor a silane compound was added, and therefore the lithium ion battery was poorer in both high-temperature cycling performance and low-temperature discharge performance. In Comparative Example 2, only SO₂ was added, and in Comparative Example 3, only tris(trimethyl)silane phosphate was added. Although the high-temperature cycling performance and low-temperature discharge performance of the lithium-ion battery had been improved to some extent, the extent of improvement was still not enough to meet actual usage requirements.

It can be seen from the test results of Examples 1 to 9 that the SO₂ content in Example 1 was excessively low, so that the passivation film formed by SO₂ on the surface of the positive electrode and the SEI film formed on the surface of the negative electrode were inadequate to effectively prevent further reactions between the electrolyte and the positive and negative electrode active materials. Therefore, the high-temperature cycling performance and low-temperature discharge performance of the lithium-ion battery could be improved, but the improvement was not obvious. The SO₂ and silane compound contents were both moderate in Examples 2 to 8, and therefore the lithium-ion battery could have both good high-temperature cycling performance and good low-temperature discharge performance. The SO₂ content in Example 9 was excessively high, and oxidative decomposition products of the excessive SO₂ could accumulate on the surface of the positive electrode, increasing impedance of the passivation film formed on the surface of the positive electrode, unfavorable for improving the high-temperature cycling performance of the lithium-ion battery.

It can be seen from the test results of Example 6 and Examples 10 to 16 that the silane compound content in Example 10 was too low to form a complete passivation film on the surface of the positive electrode, which was inadequate to prevent further contact between the electrolyte and the positive electrode active material, thereby being not conducive to improving the high-temperature cycling performance of the lithium-ion battery. The silane compound contents in Example 6 and Examples 11 to 15 were moderate, and therefore the lithium-ion battery had both good high-temperature cycling performance and good low-temperature discharge performance. The silane compound content in Example 16 was excessively high, and the excessive silane compound could accumulate on the surfaces of the positive and negative electrodes, increasing the film-forming impedance on the surfaces of the positive and negative electrodes, unfavorable for improving performance of the lithium-ion battery.

In conclusion, it should be noted that the foregoing embodiments are merely intended for describing the technical solutions of this application but not for limiting this application. Although this application is described in detail with reference to such embodiments, persons of ordinary skill in the art should understand that they may still make modifications to the technical solutions described in the embodiments or make equivalent replacements to some or all technical features thereof, without departing from the scope of the technical solutions of the embodiments of this application.

What is claimed is:

1. An electrolyte, comprising:
a lithium salt;
an organic solvent; and
an additive;
wherein
the additive comprises a sulfur-containing compound and a silane compound; and
the sulfur-containing compound is selected from one or more of sulfur hexafluoride, sulfuryl fluoride, sulfur dioxide, sulfur trioxide, carbon disulfide, dimethyl sulfide, and methyl ethyl sulfide.

2. The electrolyte according to claim 1, wherein the silane compound is selected from one or more of compounds represented by formula 1, formula 2, and formula 3: 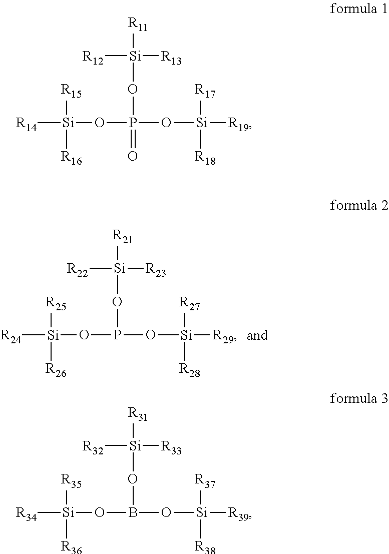
wherein R₁₁, R₁₂, R₁₃, R₁₄, R₁₅, R₁₆, R₁₇, R₁₈, R₁₉, R₂₁, R₂₂, R₂₃, R₂₄, R₂₅, R₂₆, R₂₇, R₂₈, R₂₉, R₃₁, R₃₂, R₃₃, R₃₄, R₃₅, R₃₆, R₃₇, R₃₈, and R₃₉ are each independently selected from one or more of C1 to C6 alkyl groups or C1 to C6 haloalkyl groups.

3. The electrolyte according to claim 1, wherein the silane compound is selected from one or more of tris(trimethyl)silane phosphate, tris(trimethyl)silane phosphite, tris(trimethyl) silane borate, tris(triethyl)silane phosphate, tris(triethyl)silane phosphite, tris(triethyl)silane borate, tris(trifluoromethyl)silane phosphate, tris(trifluoromethyl)silane phosphite, tris(trifluoromethyl)silane borate, tris(2,2,2-trifluoroethyl)silane phosphate, tris(2,2,2-trisfluoroethyl)silane phosphite, tris(2,2,2-trifluoroethyl)silane borate, tris(hexafluoroisopropyl)silane phosphate, tris(hexafluoroisopropyl)silane phosphite, and tris(hexafluoroisopropyl) silane borate.

4. The electrolyte according to claim 1, wherein the sulfur-containing compound is selected from one or more of sulfur hexafluoride, sulfuryl fluoride, sulfur dioxide, and sulfur trioxide.

5. The electrolyte according to claim 1, wherein mass of the sulfur-containing compound is 0.1% to 8% of total mass of the electrolyte.

6. The electrolyte according to claim 5, wherein the mass of the sulfur-containing compound is 0.5% to 5% of the total mass of the electrolyte.

7. The electrolyte according to claim 1, wherein mass of the silane compound is 0.1% to 5% of total mass of the electrolyte.

8. The electrolyte according to claim 7, wherein the mass of the silane compound is 0.1% to 3% of the total mass of the electrolyte.

9. The electrolyte according to claim 1, wherein in the electrolyte, a mass percentage of the sulfur-containing compound is greater than a mass percentage of the silane compound.

10. A lithium-ion battery, comprising:
a positive electrode plate, comprising a positive electrode current collector and a positive electrode membrane that is disposed on at least one surface of the positive electrode current collector and that comprises a positive electrode active material;
a negative electrode plate, comprising a negative electrode current collector and a negative electrode membrane that is disposed on at least one surface of the negative electrode current collector and that comprises a negative electrode active material;
a separator; and
an electrolyte;
wherein the electrolyte is the electrolyte according to claim 1.

11. The lithium-ion battery according to claim 10, wherein the positive electrode active material is selected from one or more of lithium nickel cobalt manganese oxides, lithium nickel cobalt aluminum oxides, and compounds obtained by adding other transition metals or non-transition metals to such compounds.

12. The lithium-ion battery according to claim 10, wherein the negative electrode active material is selected from one or more of carbon materials and silicon-based materials.

13. An apparatus, wherein the apparatus comprises the lithium-ion battery according to claim 10.
